(19) United States
(12) Patent Application Publication
(10) Pub. No.: US 2014/0376872 A1
(43) Pub. Date: Dec. 25, 2014

(54) VIDEO AND TEXT INTEGRATION SYSTEM AND METHOD FOR OFFICIAL RECORDINGS

(71) Applicant: VidText, Inc., San Francisco, CA (US)

(72) Inventor: Bradford J. Lipetz, San Francisco, CA (US)

(73) Assignee: VidText, Inc., San Francisco, CA (US)

(21) Appl. No.: 14/311,015

(22) Filed: Jun. 20, 2014

Related U.S. Application Data
(60) Provisional application No. 61/837,591, filed on Jun. 20, 2013.

(51) Int. Cl. G11B 27/10; H04N 5/765; G10L 15/26; G11B 27/34

(52) U.S. Cl. CPC G11B 27/10; G11B 27/34; H04N 5/765; G10L 15/265
USPC 386/201

(57) ABSTRACT

A system for providing an official recording of a legal proceedings includes one or more computer systems, a stenographic machine, a video recording device, and an audio recording device. Text file input from the stenographic machine is synchronized with video and audio data and delivered to appropriate parties. Starting and stopping of recording may be controlled based on outputs of the stenographic machine. A separate start/stop device may be coupled to a computer system recording video and audio and storing it locally. The start/stop device may provide visible and/or audible signals indicating when recording is occurring. Real-time concurrent display of textual data from the stenographic machine with video and/or audio data being received may also be provided.

### RELATED APPLICATION

This application claims the priority benefit of U.S. Provisional Application Ser. No. 61/837,591, entitled “Vidtext”, filed Jun. 20, 2013, the disclosure of which is incorporated by reference herein in its entirety

### BACKGROUND

1. Field of the Invention

This invention relates to systems and methods for integrating video and text for legal proceedings, such as a deposition.

2. Background of the Invention

Hiring a qualified, dedicated videographer to record legal deposition and trial testimony may be cost prohibitive for some litigants. Although, most current State and Federal codes of evidence allow for a CSR (Certified Shorthand Reporter) or a licensed Attorney to create video recordings of depositions, generally, neither party is equipped to produce them.

The systems and methods disclosed herein provide an improved approach for generating a record of a deposition including video (including voice recording) and a transcription by a CSR.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A and 1B are images of an interface in accordance with an embodiment of the present invention;

FIGS. 2A through 2C are schematic block diagrams of components for implementing methods in accordance with an embodiment of the present invention;

FIGS. 3A through 3C are process flow diagrams of methods for generating video and textual records of a deposition in accordance with an embodiment of the present invention;

FIG. 4 is a process flow diagram of a method for generating a combined video and text file in accordance with an embodiment of the present invention;

FIGS. 5A and 5B are process flow diagrams of methods for delivering a combined video and text file in accordance with an embodiment of the present invention;

FIG. 6 is a schematic block diagram of a computer system suitable for implementing methods in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for recording legal deposition and trial testimony using a computer, a connected camera and audio device to capture a combination of audio, video, text and CART (Communication Access Real-time Translation) generated notes. Methods are disclosed that meet current legal admissibility standards for use at trial within the United States and feature a custom user interface engineered for fail-safe recording by a Certified Shorthand Reporter (CSR) or a licensed Attorney.

CART notes and user entered text notes may be used for a variety of commercial and non-commercial uses, including, legal proceedings, assisted learning, distance learning, language translation, language learning and corporate meetings where synchronized text combined with video promote accuracy and understanding.

CART, also called open captioning or real-time stenography, or simply real-time captioning, is the general name of the system that court reporters, closed captioners, and others use to convert speech to text. A trained operator uses keyboard or stenography methods to transcribe spoken speech into written text.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

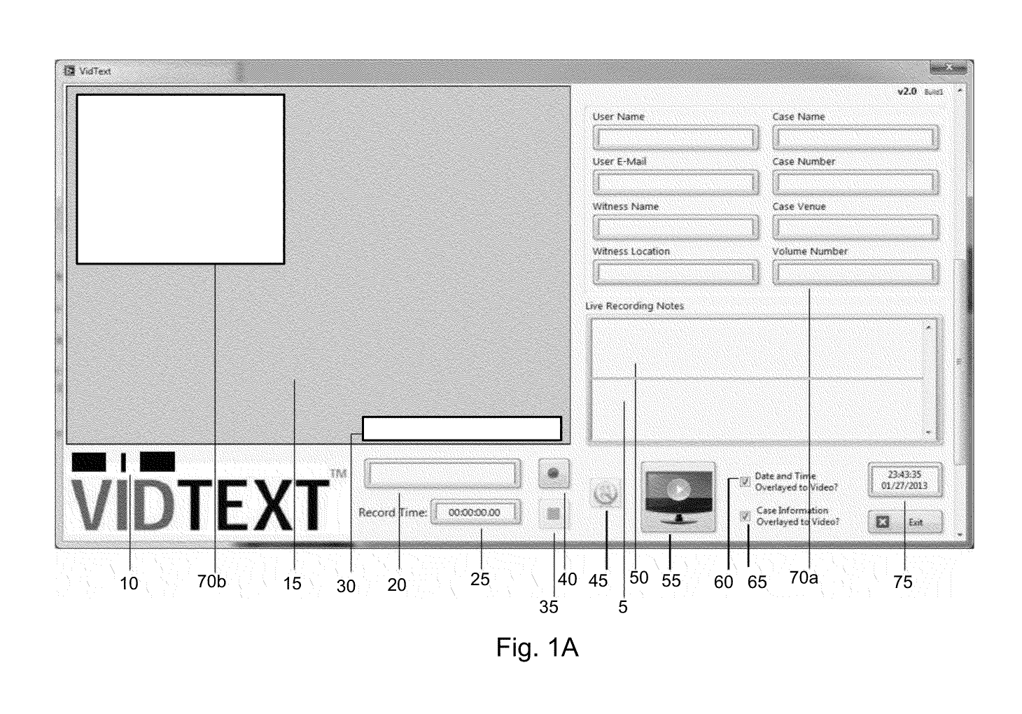

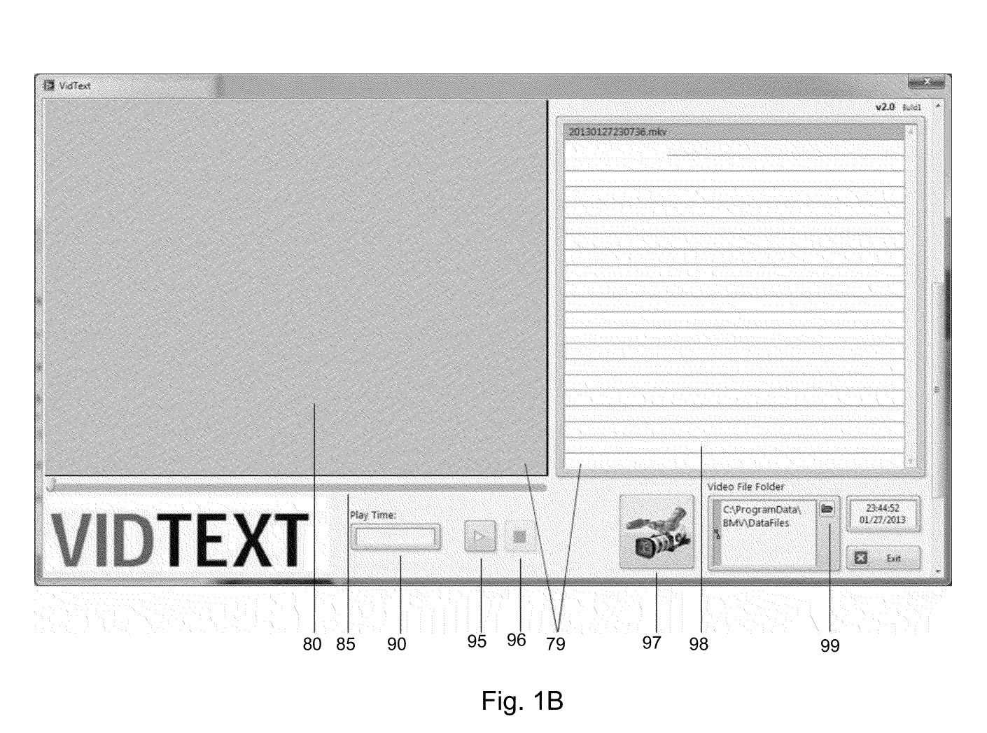

Referring to FIG. 1A, an interface for software implementing the methods disclosed herein may be as shown. For example, the interface may include a field 5 in which contact information at which a copy of a data file generated according to the methods described herein may be ordered. The live recording notes field 5 of FIG. 1A enables input of information about the video content contained in a specific video segment being recorded at the time of input of the information. That information may be used for manual synchronization of the video and text files. It directs a software module (local or remote) to prepare the video files for synchronization to the ASCII text files. Since the Live Recording Notes information is tied to a specific video segment, that field is automatically cleared once the video recording is stopped. A drop down menu in the live recording notes field 5 may facilitate selection of information that is frequently found in the Live Recording Notes field and input of selected information into the live recording notes field. In some embodiments, some or all of the information entered in some or all of the other fields is remembered and contained in the titling file that is paired with the video files for that day's testimony or a particular volume.

A field 10 may a level (e.g. loudness) of audio being detected by an audio recording device, e.g. microphone. Field 15 may display video as it is received from a video recording device. Field 20 may list a status of recording capture, i.e. recording, standby, audio failure notification, or some other status indicator. Field 25 may be a recorded time counter. Field 25 may indicate a total amount of time for which audio and/or video data has been recorded. Field 30 may include a time and/or date stamp that is displayed over the video date and may be recorded imposed on the video data for time and date verification purposes. Element 35 may include a “stop” interface element that, when clicked or otherwise selected, invokes stopping of recording video and/or audio data. Stopping may result in the creation of a file that is uniquely identified in order to provide an official record of what occurred during a recorded event, such as a deposition. Element 40 may be a “start” interface element that, when clicked or otherwise selected, invokes commencement of recording of audio and/or video signals. Starting of recording may be invoked by selection of element 40, keystroke control based on CART inputs, or voice recognition control. Element 45 may, when clicked or otherwise selected, grant or restrict access to recording devices and settings for such devices. Field 50 may, when clicked or otherwise selected, invoke an interface for inputting notes that will be associated with a file containing data being recorded. The recording notes input may be associated with a point in a recorded at which the notes were provided, such as using a time the field 50 was selected as the time when a note was received.

Element 55 may, when clicked or otherwise selected, invoke a player/viewer interface. The player/viewer interface may provide an interface for invoking playback of recorded video and/or audio, fast forwarding through recorded video and/or audio, and rewinding through recorded video and/or audio.

Element 60 may, when clicked or otherwise selected, invoke the overlay of a date and time over video images stored. If overlay is currently being performed, interaction with element 60 may invoke ending of overlay of date and time data over video images stored based on video data being received.

Element 65 may, when clicked or otherwise selected, invoke the overlay of case information over video images stored. If overlay is currently being performed, interaction with element 65 may invoke ending of overlay of case information over video images stored based on video data being received.

Fields 70a may receive date used to catalog or identify a recording. Fields 70a may include fields for a user name, user email, witness name, witness location, case name, case number, case venue, a volume number, or other data fields. Some or all of the data of the fields 70a may be overlaid or not overlaid depending on a state of element 65. The overlaid data may be displayed in area 70b of video images being recorded in accordance with the methods described herein.

Field 75 may display a current data and time as obtained from a verifiable source, such as from remote source accessed over the Internet.

FIG. 1B illustrates an interface for viewing files generated according to the methods described herein. The interface of FIG. 1B may be displayed responsive to selection of interface element 55 of the interface of FIG. 1A. The interface of FIG. 1B may include some or all of the interface elements of FIG. 1A as well as the interface elements shown. For example, the interface may additionally include a field 79 showing a portion of a transcript as input by a stenographer, such as through the CART system. Field 80 may display playing video images, which may include some or all of the overlaid data described above with respect to FIG. 1A. Element 85 may include a playback/search bar that indicates where in a recording a currently displayed video image is located. Field 79 may show a portion of a transcript corresponding to a currently displayed video image.

Elements 95 and 96 may invoke starting and stopping of playback of a file being viewed using the illustrated interface. Element 97 may invoke display of the interface of FIG. 1A for monitoring and controlling recording of video and/or audio data. Element 98 may include text displayed in the field 79, i.e. actual stenographic text being displayed synchronously with playback of video data. Element 99 may display a file path on a local or remote computer system at which the data file being viewed is stored.

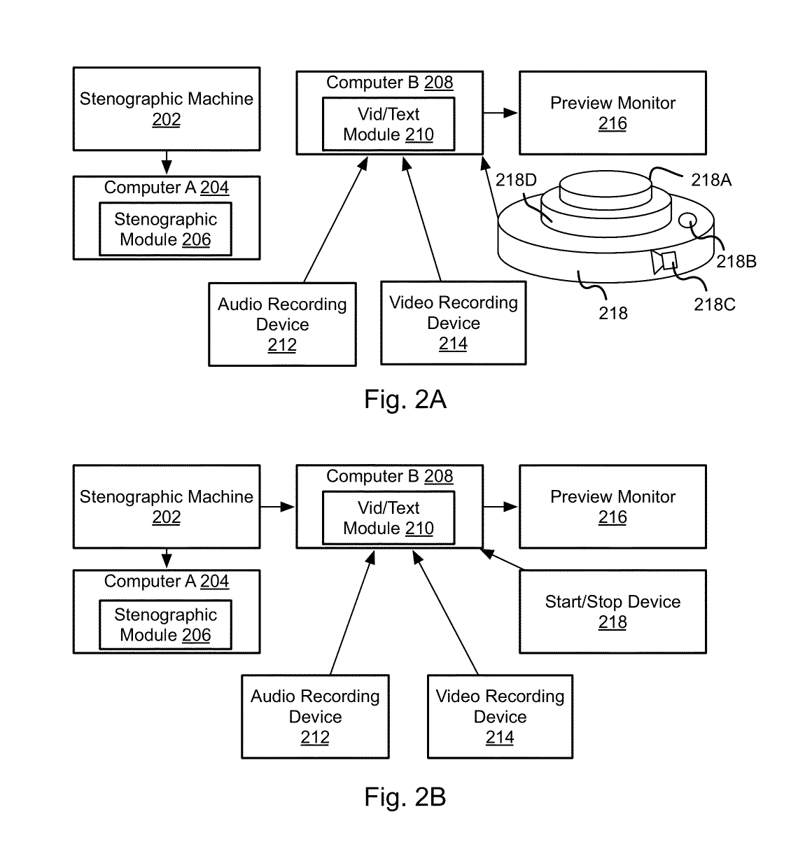

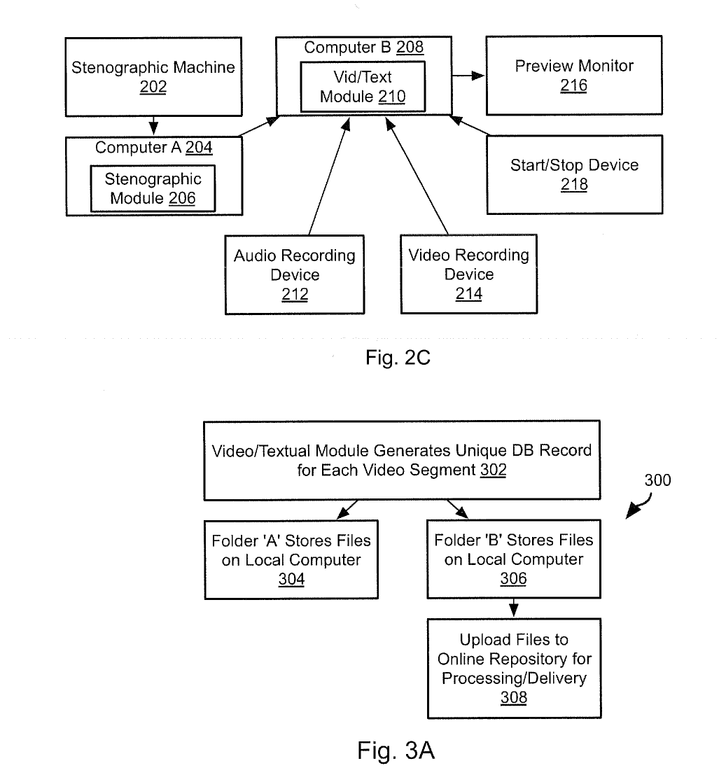

FIGS. 2A-2C illustrate components that may implement methods disclosed herein. For example, a stenographic machine may be operably coupled to a computer 204 (“computer A”) hosting a stenographic module 206. The stenographic module may receive textual data from the stenographic machine 202 either periodically or for each keystroke received on the stenographic machine. The data received from the stenographic machine may be other than conventional characters (e.g. ASCII or Unicode) but rather be phonetic symbols and other non-printed characters used for courtroom reporting, such as are used in the CART system.

Computer A may output text or symbols as received from the stenographic machine 202 to another computer 208 (“computer B”). Computer B may execute a video/textual module 210 implementing the interfaces of FIGS. 1A and 1B as well as some or all of the methods disclosed herein.

Computer B may have a preview monitor 216 coupled thereto, such as a display device on which the interfaces of FIGS. 1A and 1B may be displayed. In some embodiments, a start/stop device 218 may be connected to a USB port of a computer, such as computer B. The start/stop device 218 may be a keyboard or a dedicated input/output device having one or more controls designed exclusively for use with the video/textual module 210. For example the user plugs the start/stop device 218 into computer B before or after setting up the system at the beginning of the recording session. The start/stop device 218 may also be connected to the user's computer via Bluetooth, WiFi, other wireless connectivity. In some embodiments, the start/stop device 218 may be a foot pedal.

In some embodiments, the user may have access to a large button 218A defined on the start/stop device 218, which is easy to press with one hand with very little pressure required. This button 218A may have positive tactile feedback so the user can feel that it has been pressed successfully. This button 218A may also provide auditory feedback so that when the button is pressed successfully, a sound is emitted that can be heard by the user and others in the immediate vicinity. In operation, pressing of the button invokes starting if recording is not currently being performed and stopping if recording is currently being performed. In operation, the user presses this button 218A to start and stop the recording of the video camera by the video/textual module 210.

In some embodiments, this button 218A may also include within, on the top of the button, around the perimeter of the button, or at some other location, a light 218B. When the user presses the button 218A to start recording, this light 218B can flash intermittently alerting the user and others present in the immediate vicinity that the recording of video has begun. Alternatively, the button 218A can have a light 218B that remains on once the user has pressed it to start the recording of video. This will alert the user and others present in the immediate vicinity that the recording of video has begun.

In some embodiments, the start/stop device provides audible feedback from a speaker 218C in the form of a recorded spoken word or phrase such as “On the record” once the user has pressed it to start the recording of video. This will alert the user and others present in the immediate vicinity that the recording of video has begun.

In some embodiments, this button can be powered by the USB connection to the computer. Alternatively, it can be powered via a cord to an AC outlet. It can also be powered by the use of a battery contained within the housing of the button. In some embodiments, the button 218A can contain a word, a phrase and/or a logo which will make it a recognizable branded hardware component. This word, phrase or logo will differentiate the system from a system manufactured by a competitive company.

In operation during playback, the user can use a ring 218D built around the perimeter of the button 218A as a jog wheel. In some embodiments, the user may move the ring 218D in a clockwise or counter clockwise direction with the finger or thumb. In some embodiments, this ring 218D can have a tactile feel giving the user a sensory feedback in the form of a vibration when the wheel is moved by the user. This will make it easier for the user in operation of the wheel to advance quickly through the recorded video file or to go back to a previous portion of the video file. This is commonly referred to as fast forward and rewind respectively.

In some embodiments of the start/stop device 218 in playback mode the user can use the button 218A to play a portion of the video and stop the playback as opposed to using the button 218A to start video recording and stop video recording when in record mode.

Computer B may further be coupled to an audio recording device 212, i.e. microphone and a video recording device 214. Video recording device 214 may be an independent video recording device or an integrated video device mounted to a common housing as computer B. As shown in FIG. 2A, in some embodiments neither the stenographic machine 202 nor computer A are coupled to computer B. In such embodiments, stenographic data may be recorded separately from video data and stenographic data and these data files may be combined subsequently.

As shown in FIG. 2B, in an alternative embodiment, stenographic machine 202 is coupled to computer B. As noted above, keystrokes and control signals from the stenographic machine 202 may be used to start and stop audio and/or video recording by computer B. For example, a foot pedal used to start and stop transcription using the stenographic machine may also be used to start and stop recording of video.

As shown in FIG. 2C, computer A may be coupled to computer B and keystrokes and control signals from the stenographic machine 202 may be transmitted to computer B by way of computer A. In some embodiments, only stenographic data may be transmitted, such as upon completion of a file.

In the embodiment of FIG. 2A, a user may begins a new job or “volume” when recording a deposition by opening the video/textual module 210 on computer B and entering information on Computer B in some or all of the following fields which are shown on computer B's screen or monitor: user name, case name, user e-mail, case number, witness name, case venue, witness location, volume number, and live recording notes. A feature of the software in some embodiments allows this information to be entered at anytime during the recording of the deposition. Another feature of video/textual module 210 in some embodiments is that it creates a titling file with all of this information entered by the user and pairs it with the corresponding video file making it possible to synch this information in the eventual video and text synchronization for synchronized playback and viewing.

In the embodiment of FIG. 2B, a user may enter the information in the fields on the monitor of computer B directly from the stenographic machine which is connected directly to computer B. In the embodiment of FIG. 2C, the user enters the information in the fields on Computer B's monitor from either the Stenographic machine or from Computer A. In FIG. 2C, computer A is connected to computer B.

In the embodiment of FIG. 2A, a user may begin recording of video testimony by pressing the start/stop device 218 or by hitting a designated key on the keyboard of computer B. In some embodiments, the video/textual module 210 may be configured so that the user can enter information in the titling fields (e.g. some or all of the fields of FIG. 1A) and turn video recording on or off from the user's stenographic machine 202 or from computer A as shown in Schematics 2B and 2C.

In some embodiments, a video/textual module 210 may cause one or more of the following areas of one or more of the computers A and B to flash for some designated period of time to indicate the video is being recorded. For example, flashing or some other visible indicator of one or more of a recording notification on the monitor of Computer B, a border or some other portion around the interface of FIG. 1A on the monitor of Computer B, a portion of the start/stop device 218, or some other portion of some other device. This remote visual cue makes it possible for others present during the deposition to see that video is being recorded. In some embodiments, the video/textual module 210 may further invoke an audible cue that also indicates that video is being recorded and/or has stopped.

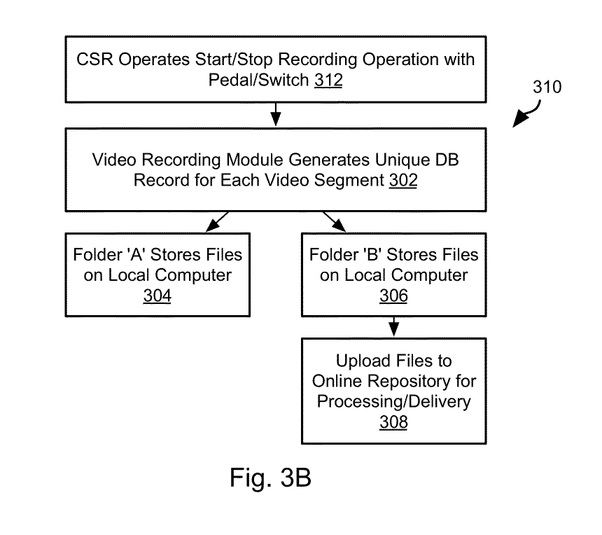

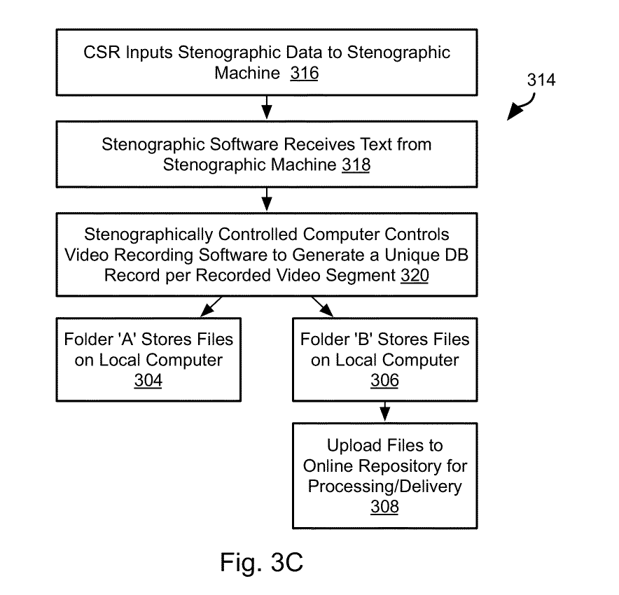

Referring to FIG. 3A, a method 300 may be executed by any of the systems of FIGS. 2A through 2C, such as responsive to instructions received through one of the interfaces of FIGS. 1A and 1B. The method 300 may include generating by a video/textual module 210 a unique database record for each video segment of a session. For example, for each starting and stopping of recording a video segment may be generated and stored 210 as a unique database record. A copy may be stored 304 in a first location (e.g. “folder A”). A second copy may be stored 306 in a different location (e.g. “folder B”). The second copy may be uploaded 308 to an online repository for processing and delivery. For example, the second copy may be stored in a cloud-based storage location such as DROPBOX or some other cloud-based storage system

FIG. 3B illustrates an alternative method 310. The method 310 may include a CSR operating 312 a start and stop switch to start and/stop recording operations in order to record one or more video segments. In some embodiments, starting and stopping of recording may be performed responsive to actuation of a pedal or other switch. The method 310 may include performing steps 302-308 in a same manner as for the method 300.

FIG. 3C illustrates yet another alternative method 314. The method 314 may include inputting 314 by a CSR inputs of stenographic data to a stenographic machine. Stenographic software receives 318 text from the stenographic machine. A stenographically controlled computer may control video recording software according to outputs of the stenographic machine and generates unique database record for each video segment generated.

In some embodiments, rather than receiving textual data from a stenographic machine, stenographic data may be automatically extracted from audio data (speech-to-text) according to any method known in the art. In such embodiments, an individual may be present to start and stop recording of audio and video data. Stenographic data may then be subsequently extracted from audio data or performed as the audio data is being received.

The method 314 may further include performing steps 304-308 as for the method 300.

In some implementation of the methods of any of FIGS. 3A through 3C, during recording, video is saved to a hard drive, or other persistent storage device, of Computer B. Once the stop button is pressed, the video is still saved to the hard drive but may also copied from the hard drive and saved to a folder linked to a remote storage platform (e.g. DROPBOX) on computer B if computer B is offline. If computer B is online, the video file may be saved online to a remote storage platform using the platform's remote server. The redundant storage on computer B and the remote storage platform provides a degree of redundancy.

In some embodiments, during recording, video data is sent in real time to the hard drive, or other persistent storage device of computer B, but the paired titling file is not sent to a remote storage platform until the Stop button is pressed for a specific video segment.

In some embodiments, a user may close software implementing the methods of the present application when video recording is completed for that day. In some embodiments, the software may remind a user to enter information in the titling fields (e.g. some or all of the fields of FIG. 1A) each time the software is reopened.

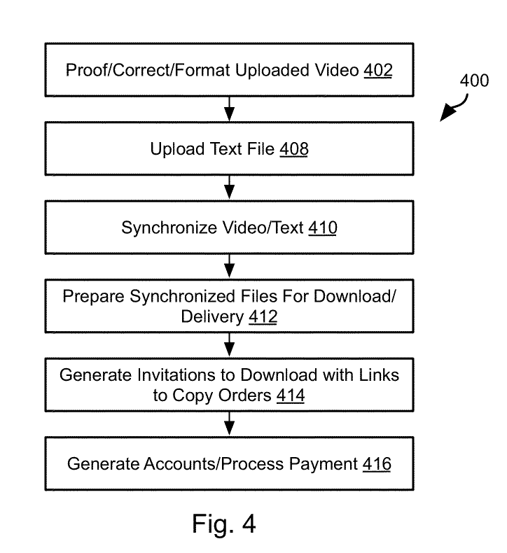

Referring to FIG. 4, at the completion of the video recording of testimony or thereafter, the user may obtain email addresses of parties who are authorized to receive recorded testimony from that deposition. The user may record this information into an account for a specific job. In some embodiments, a video/textual module 210 may then send an email to each party authorized to receive the recorded testimony with a link to order a synchronized copy of the testimony. The synchronized copy of the testimony may be generated according to the method 400 of FIG. 4.

For example, prior to distributing synchronized copies, the user may upload to a remote processing server, a test file (e.g. ASCII, Unicode, or some other format) of the testimony recorded on the Stenographic machine which corresponds to the video and titling paired files for that testimony. This initiates the synchronization process. In some embodiments, an email reminder may be transmitted to the user to upload text files of testimony in a timely fashion so attorneys can order copies as soon as they need them.

The method 400 may include, prior to synchronization of the video and text files, a step 402 of some or all of proofing, correcting, formatting the one or more video segments captured according to the methods described herein. For example, this may include manual proofing and correction of the video files as necessary to remove any errors from the recordings. For example, the person performing the proofing and correction of the video files looks at the live recording notes for cues to help in the process such as indications that a certain piece of testimony is off the record or that a portion was missed when the Start or Stop button was not pressed at the correct time. The video files as modified at step 402 may then be joined and formatted. The corrected, joined and formatted files are then placed in a folder awaiting the ASCII text file for auto synchronization. Preparation of audio/video files for synchronization to text data may be performed using computer analysis of a digital audio recording and its corresponding written text data to locate missing or non-corresponding digital audio information for removal or correction.

The method 400 may further include uploading 408 the text file and synchronizing 410 the video and text files. Synchronizing the video and text files may include any synchronization method known in the art. For example, markers or time stamps in a text file may be matched or placed in sequence with time stamps embedded or otherwise associated with the video data.

The text and video files as synchronized at step 410 may be prepared for download or delivery. For example, a file or folder containing the video file, text file, a titling file, and other information input to the interface of FIG. 1A may be packaged or otherwise prepared 412 for retrieval or transmission to an interested party.

In some embodiments, invitations may be generated 414 and transmitted to interested parties, the invitations including a link to the files as prepared at step 412 or including instructions on how to obtain the file. Upon receiving a request to obtain the prepared files, at step 416 an account may be created and payment processed. The prepared file may then be transmitted, streamed, or otherwise made available to the requesting party. Account creation and payment processing may be performed by an ecommerce website according to any method known in the art.

The method 400 may be executed by a server system remote from computer B or may be performed by computer B itself. In some embodiments, when the synchronization is complete, synchronized files are copied to media where they can be downloaded or delivered according to the method 400.

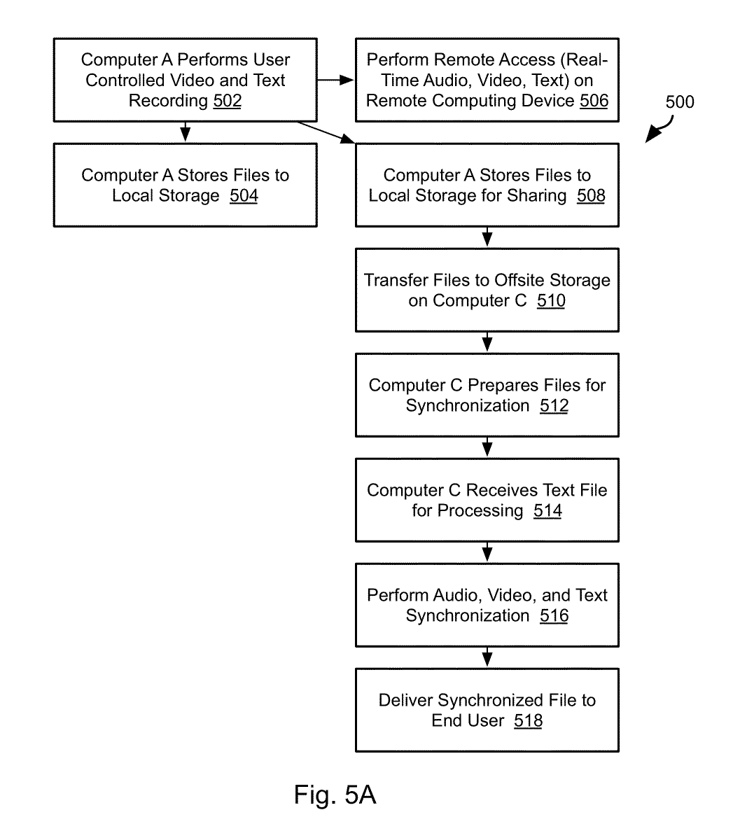

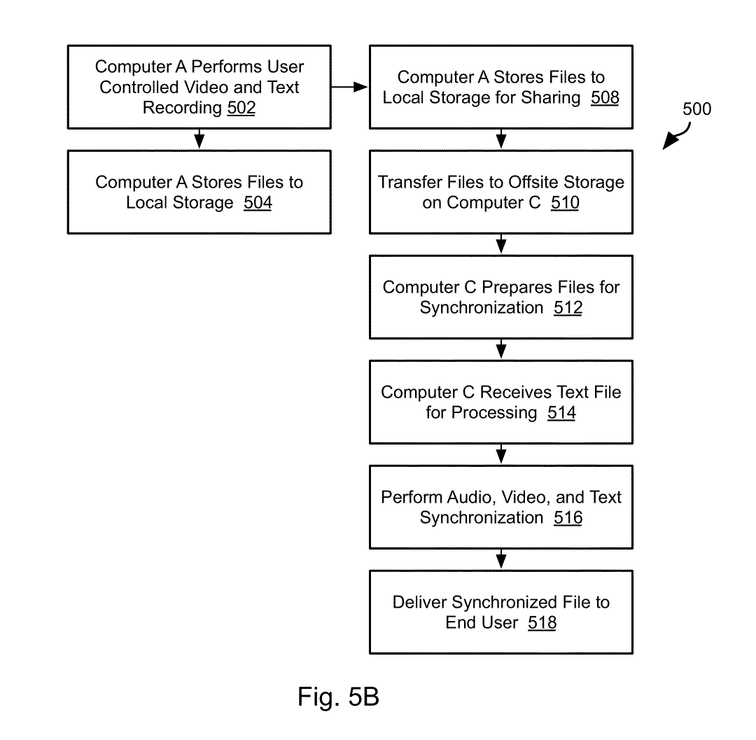

Referring to FIGS. 5A and 5B, in some embodiments systems described herein may implement the illustrated method 500. In particular, computer A performs 502 user controlled video and text recording and computer A stores 504 files to local storage. Computer A may further provide 506 remote access to real-time audio, video, and text on a remote computing device (e.g. computer B). Computer A may store 508 an additional file in local storage for subsequent sharing.

The method 500 may further include transferring 510 files (video, audio, text) to offsite storage on a different computer (computer C). Computer C may prepare 512 files for synchronization, e.g. the video and/or audio files as described with respect to the method 400 of FIG. 4. Computer C may further receive 514 text files for processing and perform 516 synchronization of video, audio, and text files, such as described above with respect to FIG. 4. The method 500 may further include delivering 518 the synchronized files to an end user either recorded on physical media or transmitted to an end user's computing device. As shown in Fig. B, in some embodiments, step 506 of performing a remote access to real-time audio, video, and text data may be omitted in some embodiments.

In some embodiments, the methods disclosed above are performed by a computer system containing a flash memory hardware drive onto which recorded video footage is stored. In this way the system provides the user backup for videos, notes, case data and transcripts. In some embodiments, the system may contain a hardware key in the form of a dongle that is connected to the user's computer via a USB port. This may advantageously enable software licensing options and offer multiple licensing modes locked into the hardware key to supply flexible licensing protection. The USB key may include memory that protects software against piracy and illegal use by allowing access and execution of the protected software only when the key is connected to the computer. In operation, the user can access a built-in license key generator which assigns access rights to the user by the developer of the system or by third party, e.g. EPIMEDIA.

In some embodiments, a system ad disclosed herein may further provide a security encryption mechanism to encrypt sensitive data associated with the deposition that is being video recorded. In an encryption scheme, the message or information (referred to as plaintext) may be encrypted using an encryption algorithm, turning it into an unreadable ciphertext. This is usually done with the use of an encryption key, which specifies how the message is to be encoded. Any adversary that can see the ciphertext should not be able to determine anything about the original message. An authorized party, however, is able to decode the ciphertext using a decryption algorithm, that usually requires a secret decryption key that adversaries do not have access to. For technical reasons an encryption scheme usually needs a key-generation algorithm to randomly produce keys.

In some embodiments, a user of the systems disclosed herein may further have access to an omnidirectional and/or directional high quality set of microphones that provide superior recording quality. These are connected to the computer via cabling or can be connected via Bluetooth, WiFi, or some other wireless connectivity. Omnidirectional microphones can pick up sound from virtually any direction. This design can be useful when a device needs to pick up ambient sound or is used in an environment where sound sources are moving and it is not practical to move the microphone along with them. A directional microphone is one that picks up sound from a certain direction, or a number of directions, depending on the model involved.

In some embodiments, a system as disclosed herein may further employ active noise cancellation in video recording. Active noise cancellation is generally achieved through the use of analog circuits or digital signal processing. Adaptive algorithms are designed to analyze the waveform of the background aural or non-aural noise, then based on the specific algorithm generate a signal that will either phase shift or invert the polarity of the original signal. This inverted signal (in antiphase} is then amplified and a transducer creates a sound wave directly proportional to the amplitude of the original waveform, creating destructive interference. This effectively reduces the volume of the perceivable noise.

In some embodiments, a system as disclosed herein may further include a cellular high speed data card so that it can provide the network connection for video uploads. A cellular wireless high speed data card takes advantage of cellular telephone carrier's networks to connect a user's computer (e.g. computer A or B) to a remote computer (e.g. computer C). In operation, the user sends video recorded files over a network to a remote system, the remote system may communicate to the user via an on-screen message the status of a file, video or deposition project.

In some embodiments, a system as disclosed herein may further be configured to enable a user to stream or share a live video signal with remote participants. Streaming refers to content delivered live over the Internet. It requires a camera for the media, an encoder to digitize the content, a media publisher, and a content delivery network to distribute and deliver the content. Internet Protocol Multicast provides a means to send a single media stream to a group of recipients on a computer network. A multicast protocol, usually Internet Group Management Protocol, is used to manage delivery of multicast streams to the group of recipients on a local area network (LAN).

In some embodiments, a system as disclosed herein may further be configured to stream or share the CSR's real time feed alongside streamed video. This real-time captioning involves mixing the text file with the video, which is done through captioning software and a piece of hardware called a captioning encoder. The encoder is placed in the video stream before the video is broadcast to the Internet or some other network.

In some embodiments, a system as disclosed herein may further be configured to enable the user to employ a “countdown” clock which displays the time elapsed or remaining during a video recorded testimony. This information is displayed on an interface, such as the interface of FIG. 1A. In operation, the user can set the time to be counted down prior to the beginning of the video recording session. This may be advantageous in some contexts because in California and in certain Federal courts, the testimony for a single person being deposed cannot exceed seven hours by law. During a deposition, there may be multiple pauses in testimony so it is advantageous to be able to see in real time, the amount of time remaining for a single person being deposed

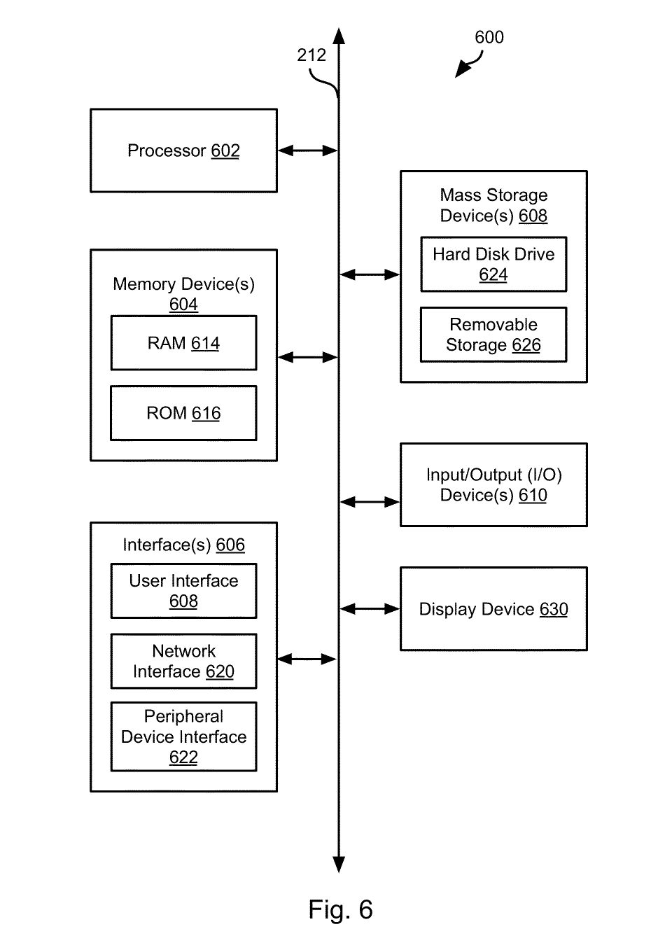

FIG. 6 is a block diagram illustrating an example computing device 600. Computing device 600 may be used to perform various procedures, such as those discussed herein. Computing device 600 can function as a server, a client, or any other computing entity. Computing device can perform various monitoring functions as discussed herein, and can execute one or more application programs, such as the application programs described herein. Computing device 600 can be any of a wide variety of computing devices, such as a desktop computer, a notebook computer, a server computer, a handheld computer, tablet computer and the like.

Computing device 600 includes one or more processor(s) 602, one or more memory device(s) 604, one or more interface(s) 606, one or more mass storage device(s) 608, one or more Input/Output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Display device 630 includes any type of device capable of displaying information to one or more users of computing device 600. Examples of display device 630 include a monitor, display terminal, video projection device, and the like.

Interface(s) 606 include various interfaces that allow computing device 600 to interact with other systems, devices, or computing environments. Example interface(s) 606 include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more user interface elements 618. The interface(s) 606 may also include one or more peripheral interfaces such as interfaces for printers, pointing devices (mice, track pad, etc.), keyboards, and the like.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the foregoing disclosure various functions are ascribed to different computer systems (computer A, computer B, computer C) however some or all of the functions associated with two or more individual computers may be performed by a single computer. For example, computer A may be coupled to a stenographic machine and further perform the functions associated with computer B. Likewise, the remote processing of text, video, and audio files may instead be performed by computer A or computer B, rather than computer C.

In some embodiment some or all of the computers A through C may be coupled to a support computer system that enables a remote user to take control of computers A through C for training and troubleshooting purposes. For example, a service such as GOTOMEETING. In some embodiments, a monitoring component installed on some or all of computer systems A through C may monitor use of the software components discussed above. In particular, where the monitoring component detects a high frequency of errors (e.g. more than N errors per M minutes, or some other measure), a notification may be sent to the support computer system. Upon receiving this notification, a remote assistant may take control of one or both of computer A and computer B in order to, for example, start and stop recording of video. In some embodiments, errors may be reported to the support computer system by a user, such as by invoking a support module executing on computer A or computer B or by calling a support line. Response to reports of problems by any of these means, a representative may use the support computer system to take control of computer A or computer B in order to successfully record a deposition or other proceedings.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method comprising:
receiving, by a first computer system, a video recording of an audible and visible event;
receiving, by the first computer system, simultaneous with the video recording a transcription of the event; and
generating, by one of the first computer system and a second computer system, a combined file including a video file including the video recording and a text file including the transcription, the text file being synchronized with the video recording.

2. The method of claim 1, further comprising, during the event:
initiating, by one of the first computer system and a third computer system, stenographic software to receive input of the transcription of the event;
in response to initiating stenographic software to receive input of the transcription of the event, initiating, by one of the first computer system and the third computer system, output of the video recording by a video recording device.

3. The method of claim 2, further comprising, during the event:
pausing the stenographic software; and
in response to pausing the stenographic software, pausing output of the video recording by a video recording device.

4. The method of claim 1, further comprising:
during receiving of the video recording and the transcription of the event, presenting, on one of the first computing system and a third computing system, a preview simultaneously displaying a most recent portion of the transcription and the video recording.

5. The method of claim 1, further comprising:
providing a physical switch operably coupled to one of the first computing device and a third computing device; and
in response to actuation of the physical switch, pausing or initiating recording of the video recording by a video recording device.

6. The method of claim 5, wherein the physical switch further includes a perceptible indicator, the method further comprising activating the physical indicator in response to actuation of the physical switch to initiate recording of the video by the video recording device.

7. The method of claim 6, wherein activating the physical indicator comprises activating a light.

8. The method of claim 6, wherein activating the physical indicator comprises activating a speaker.

9. The method of claim 8, wherein activating the speaker comprises playing a verbal message.

10. The method of claim 9, wherein the verbal message is a voice stating “on the record.”

11. A system comprising:
a first computer system including one or more processors and one or more memory devices operably coupled to the one or more processors, the one or more memory devices comprising executable and operational data effective to cause the one or more processors to:
receive a video recording of an audible and visible event; and
receive simultaneous with the video recording a transcription of the event;
wherein one of the first computer system and a second computer system stores executable and operational data effective to the one of the first computer system and second computer system to generate a combined file including a video file including the video recording and a text file including the transcription, the text file being synchronized with the video recording.

12. The system of claim 11, wherein one of the first computer system and a third computer system is further programmed to:
initiate stenographic software to receive input of the transcription of the event; and
in response to initiating stenographic software to receive input of the transcription of the event, initiate output of the video recording by a video recording device.

13. The system of claim 12, wherein one of the first computer system and the third computer system is further configured to:
pause the stenographic software;
in response to pausing the stenographic software, pause video recording by a video recording device.

14. The system of claim 11, wherein one of the first computer system and a third computer system is further programmed to:
during receiving of the video recording and the transcription of the event, present a preview simultaneously displaying a most recent portion of the transcription and the video recording.

15. The system of claim 11, further comprising:
a physical switch operably coupled to the first computing device, the first computing device further programmed to one of pause and initiate recording of the video recording by a video recording device in response to actuation of the physical switch.

16. The system of claim 15, wherein the physical switch further includes a perceptible indicator, the physical indicator programmed to, in response to actuation of the physical switch, alternately activate and deactivate the perceptible indicator.

17. The system of claim 16, wherein the physical indicator comprises a light.

18. The system of claim 16, wherein the physical indicator comprises a speaker.

19. The system of claim 18, wherein the physical switch if further configured to cause the speaker to play a verbal message.

20. The system of claim 19, wherein the verbal message is a voice stating “on the record.”
